(19) United States
(12) Patent Application Publication
(10) Pub. No.: US 2025/0179395 A1
(43) Pub. Date: Jun. 5, 2025

(54) BLOOMING COEFFICIENT

(71) Applicant: HENKEL AG & CO. KGAA, Düsseldorf (DE)

(72) Inventors: Andreas BAUER, Kaarst (DE); Andreas GERIGK, Erkelenz (DE); Hubert SMYREK, Krefeld (DE); Manuela MATERNE, Kaarst (DE); Christian GIESEN, Nettetal (DE); Lisa RULAND, Krefeld (DE); Frank PESSEL, Düsseldorf (DE); Malte BRUTSCHY, Meerbusch (DE)

(21) Appl. No.: 18/843,260

(22) PCT Filed: Feb. 27, 2023
(86) PCT No.: PCT/EP2023/054771

§ 371 Date: Sep. 1, 2024

(30) Foreign Application Priority Data
Mar. 4, 2022 (EP) 22160242.8

(51) Int. Cl. C11D 3/50; C11B 9/00; C11D 17/00; C11D 17/04

(52) U.S. Cl. CPC C11D 3/50; C11B 9/00; C11D 17/0008; C11D 17/042; C11D 2111/12; C11D 2111/14

(57) ABSTRACT

A perfume composition including at least 15% by weight of at least one odorant having a blooming coefficient (Bc) of ≥0.5 is described. Washing or cleaning agents including the perfume composition and use of the composition or agents for washing textiles or cleaning surfaces and/or for scenting the room in which the composition or agents is applied are also described.

The invention relates to a perfume composition comprising at least one odorant having a blooming coefficient (Bc) of ≥0.5. The invention also relates to washing or cleaning agents comprising the perfume composition according to the invention and to the use of the compositions or agents according to the invention for washing textiles or cleaning surfaces and/or for scenting the room in which the composition or agent is applied. Furthermore, the invention relates to a method for washing textiles or cleaning surfaces and/or for scenting the room in which the method is carried out, wherein a perfume composition according to the invention or a washing or cleaning agent according to the invention is applied in at least one method step.

When washing or cleaning agents are used, consumers not only expect long-lasting fragrance after the product has been applied to a surface, for example textiles, but also a room-filling perfume effect during or after the application of a product. This can be, for example, the room-filling effect when drying textiles on the line, when opening the washing machine after the wash cycle, or the room-filling effect after cleaning floor surfaces.

This room-filling (perfume) effect is also referred to as the blooming effect and is defined by improved perception and intensity of fragrances in a room during or after the application of products containing this fragrance.

Surprisingly, it has been found that odorant having a certain blooming coefficient can influence the room-filling effect of a perfume composition. This effect can preferably be significantly improved by taking into account certain concentrations of these odorants in the perfume composition. This effect can be observed both during and after application.

Thus, a first aspect of the invention relates to a perfume composition comprising at least one odorant having a blooming coefficient (Bc) of 20.5, wherein the blooming coefficient is calculated according to the following formula:

$$blooming coefficient ( Bc ) = vapor pressure [ Pa ] at 25 ° C . / odor detection threshold [ µg / {m}^{3} ] .$$

The perfume composition preferably contains the at least one odorant having a blooming coefficient of ≥0.5 in a concentration of at least 1 wt. %, more preferably at least 5 wt. %, even more preferably at least 10 wt. %, even more preferably at least 15 wt. %, even more preferably at least 20 wt. %, and in particular at least 25 wt. %, based on the total weight of the perfume composition.

A further aspect of the invention relates to a washing or cleaning agent comprising a perfume composition according to the invention.

In a further aspect, the invention also relates to the use of the perfume composition according to the invention or of the washing or cleaning agent according to the invention
(i) for washing textiles and/or for scenting the room in which the composition or agent is applied; or
(ii) for cleaning surfaces and/or for scenting the room in which the composition or agent is applied.

The invention preferably relates to the use of the perfume composition according to the invention or of the washing or cleaning agent according to the invention for washing textiles or for cleaning surfaces and simultaneously for scenting the room in which the composition or agent is applied.

Finally, the invention relates to a method
(i) for washing textiles and/or for scenting the room in which the method is carried out; or
(ii) for cleaning surfaces and/or for scenting the room in which the method is carried out; characterized in that in at least one method step a perfume composition according to the invention or a washing or cleaning agent according to the invention is applied.

The invention preferably relates to a method for washing textiles or for cleaning surfaces and simultaneously for scenting the room in which the method is carried out, characterized in that in at least one method step a perfume composition according to the invention or a washing or cleaning agent according to the invention is applied.

These and other aspects, features and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate but not to limit the invention and that, in particular, the invention is not limited to these examples.

Unless indicated otherwise, all percentages are indicated in terms of wt. %. Numeric ranges specified in the format “from x to y” include the specified values. If several preferred numerical ranges are specified in this format, it is readily understood that any ranges resulting from the combination of the various endpoints are also included.

Numerical values specified herein without decimal places refer in each case to the full specified value with one decimal place. For example, “99%” stands for “99.0%”.

When reference is made herein to molar masses, this information always refers to the number-average molar mass Mn, unless explicitly indicated otherwise. The number-average molar mass can, for example, be determined by gel permeation chromatography (GPC) according to DIN 55672-1:2007-08 with THE as the eluent. The number-average molar mass Mw can also be determined by means of GPC, as described for Mn.

The expression “substantially free of” means that the corresponding component can in principle be contained in the composition according to the invention or the agent according to the invention, but is then present in an amount that is significantly below the amount usually required or used for the function of this component. In the context of the present invention, for the property “substantially free of” a particular component is therefore preferably considered to be a total amount of less than 1 wt. %, more preferably less than 0.1 wt. %, even more preferably less than 0.01 wt. %, even more preferably less than 0.001 wt. %, in particular free, i.e. below the detection limit, of this component, based on the total weight of the composition or the agent. It may also mean that the corresponding component was not added intentionally.

In the context of the present invention, the term “perfume” or “perfume composition” refers to individual odorant or fragrance compounds or mixtures of a plurality of such compounds, and thus includes, for example, synthetic products of the ester, ether, aldehyde, ketone, alcohol, and hydrocarbon type, as well as natural fragrance mixtures, such as those accessible from plant sources.

The odor of a scent/fragrance is perceived as pleasant by most people, and frequently corresponds to the odor of, for example, flowers, fruits, spices, bark, resin, leaves, grasses, mosses and roots. Thus, odorants/fragrances can also be used to mask unpleasant odors or to provide an odorless substance with a desired odor.

“At least one” as used herein includes, but is not limited to, 1, 2, 3, 4, 5, 6, and more. In relation to an ingredient, it refers to the type of ingredient and not to the absolute number of molecules. “At least one fragrance” thus means, for example, at least one type of fragrance, i.e., that one type of fragrance or a mixture of several different fragrances may be meant. Together with weight specifications, the expression relates to all compounds of the type indicated that are contained in the composition/mixture; i.e., the composition does not contain any other compounds of this type beyond the indicated amount of the corresponding compounds.

According to the invention, the perfume composition described in more detail below is characterized in that the perfume composition comprises at least 15 wt. % of at least one odorant having a blooming coefficient (Bc) of ≥0.5, wherein the blooming coefficient is calculated according to the following formula:

$$blooming coefficient ( Bc ) = vapor pressure [ Pa ] at 25 ° C . / odor detection threshold [ µg / {m}^{3} ] .$$

In order to achieve a blooming effect, there must be a sufficient number of odorant molecules in the room that must be above the odor threshold. The vapor pressure for generating a blooming effect is thus directly related to the odor threshold of each individual odorant.

The vapor pressure of the odorant at 25° C. (VP25°) is given in pascals in the context of this invention, unless otherwise stated. It is a substance- and temperature-dependent gas pressure and describes the ambient pressure below which a liquid begins to transition to a gaseous state at a constant temperature.

The vapor pressure of known odorants at 25° C. can be found in the literature. Furthermore, any suitable measurement method can be applied to determine the vapor pressure. Examples of measurement methods include, but are not limited to, the dynamic measurement method, in which the boiling temperature of the test substance is measured at a specific predetermined pressure; the statistical measurement method, in which the vapor pressure that is set in thermodynamic equilibrium in the closed system at a given temperature above a substance is measured; the effusion method, in which the substance amount that leaves a measuring cell through an opening of a known size per unit of time is determined under vacuum conditions in such a way that a return of the substance to the measuring cell can be neglected; or the gas saturation method, in which a flow of an inert gas is passed over the test substance in such a way that it is saturated with the vapor thereof, wherein the substance amount transported by a known amount of carrier gas can be measured either by collection in a suitable trap or by an online analysis method. The measurement methods are to be selected according to the expected level of the vapor pressure.

The odor detection threshold (ODT) describes the minimum concentration of a gaseous, sensorially active substance, for example an odorant, that a living being, for example a human, can still perceive with the sense of smell. In the context of this invention, this value is given in μg/m³, unless otherwise indicated.

The odor detection threshold can either be found in the literature, or, for example, without being limited thereto, can be determined by means of olfactometry, in which the odor sample is mixed with odorless clean air and presented to a plurality of test subjects. Defined dilution stages of the odor sample are observed.

The blooming coefficient (Bc) can be calculated from the vapor pressure [Pa] of the odorant at 25° C. (VP25°), and the odor detection threshold [μg/m³] of the odorant (ODT) can be calculated according to the formula mentioned above.

The perfume composition according to the invention can comprise a single odorant having a blooming coefficient of ≥0.5 or a mixture of two or more odorants, for example 1, 3, 4, 5, 6, 7, 8, 9, 10 or more odorants, each having a blooming coefficient of ≥0.5. In various embodiments, the composition can additionally comprise further odorants having a blooming coefficient below 0.5.

In preferred embodiments, the perfume composition contains at least 16 wt. %, at least 17 wt. %, at least 18 wt. %, at least 19 wt. %, at least 20 wt. %, at least 21 wt. %, at least 22 wt. %, at least 23 wt. %, at least 24 wt. % or at least 25 wt. %, for example ≥25 wt. %, ≥27 wt. %, ≥30 wt. %, ≥35 wt. %, ≥40 wt. %, ≥45 wt. % or ≥50 wt. % of at least one odorant having a blooming coefficient of ≥0.5, based on the total weight of the perfume composition.

In preferred embodiments, the perfume composition contains at least 15 wt. %, in particular at least 25 wt. %, of at least one odorant having a blooming coefficient of ≥0.5, based on the total weight of the perfume composition.

In preferred embodiments, the blooming coefficient of the at least one odorant in the perfume composition has a value of ≥0.6, ≥0.7, ≥0.8, ≥0.9, ≥1, ≥1.5, ≥2, ≥3, ≥4, ≥5, ≥6, ≥7, ≥8, ≥9, ≥10, ≥15, ≥20, ≥25, ≥30, ≥35, ≥40, ≥50, ≥55, ≥60, ≥65, ≥70, ≥75, ≥80, ≥85, ≥90, ≥95, or ≥100. When two or more odorants are present in the perfume composition, the blooming coefficients can be (virtually) identical or differ slightly or else greatly.

In various embodiments of the invention, the proportion of odorants having blooming coefficients of <0.5 is at most 50 wt. %, based on the total weight of the perfume compositions, for example at most 40 wt. %, at most 35 wt. %, at most 30 wt. %, at most 25 wt. %, at most 20 wt. %, at most 15 wt. %, or at most 10 wt. %.

In various embodiments, the perfume compositions according to the invention contain at least two different odorants, each having a blooming coefficient of ≥0.5, ≥0.6, ≥0.7, ≥0.8, ≥0.9, ≥1, ≥1.5, ≥2, ≥3, ≥4, ≥5, ≥6, ≥7, ≥8, ≥9, ≥10, ≥15, ≥20, ≥25, ≥30, ≥35, ≥40, ≥50, ≥55, ≥60, ≥65, ≥70, ≥75, ≥80, ≥85, ≥90, ≥95, or ≥100. In various embodiments, there are even three or more, for example at least 4, 5, 6, 7, or 8 odorants that meet this criterion.

In various embodiments, at least one odorant of the perfume composition according to the invention may be an aldehyde, preferably selected from adoxal (2,6,10-trimethyl-9-undecenal), anisaldehyde (4-methoxybenzaldehyde), cymal (3-(4-isopropyl-phenyl)-2-methylpropanal), ethyl vanillin, Florhydral (3-(3-isopropylphenyl) butanal), helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methyl nonyl acetaldehyde, Lilial (3-(4-tert-butylphenyl)-2-methylpropanal), phenylacetaldehyde, undecylenic aldehyde, vanillin, 2,6,10-trimethyl-9-undecenal, 3-dodecen-1-al, alpha-n-amyl cinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl) propanal, 2-methyl-4-(2,6,6-timethyl-2 (1)-cyclohexen-1-yl) butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl) propanal, 1-decanal, 2,6-dimethyl-5-heptenal, 4-(tricyclo [5.2.1.0 (2,6)]-decylidene-8)-butanal, octahydro-4,7-methane-1H-indenecarboxaldehyde, 3-ethoxy-4-hydroxybenzaldehyde, para-ethyl-alpha, alpha-dimethyl hydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymen-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3) (4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl) propanal, dihydrocinnamaldehyde, 1-methyl-4-(4-methyl-3-pentenyl)-3-cyclohexene-1-carboxaldehyde, 5- or 6-methoxyhexahydro-4,7-methane indane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolyl acetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methane indane-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-Propyl-bicyclo-[2.2.1]-hept-5-ene-2-carbaldehyde, 9-decenal, 3-methyl-5-phenyl-1-pentanal, methylnonylacetaldehyde, hexanal and/or trans-2-hexenal. Mixtures of said substances may also be used.

In various embodiments, at least one odorant may be a ketone, preferably selected from methyl-beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyl dihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, Iso-E-Super (1-(1,2,3,4,5,6J,8-octahydro-2,3,8,8-tetramethyl-2-naphthalenyl)-ethane-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, Frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl) propyl)cyclopentanone, 1-(p-menthen-6 (2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4 (5H)-indanone, 4-damascol, Dulcinyl (4-(1,3-benzodioxol-5-yl) butan-2-one), hexalone (1-(2,6,6-trimethyl-2-cyclohexen-1-yl)-1,6-heptadien-3-one), Isocyclemone E (2-acetonaphthone-1,2,3,4,5,6,7,8-octahydro-2,3,8,8-tetramethyl), methyl nonyl ketone, methyl cyclocitrone, methyl lavender ketone, Orivone (4-tert-amyl cyclohexanone), 4-tert-butylcyclohexanone, Delphone (2-pentyl-cyclopentanone), muscone (CAS 541-91-3), neobutenone (1-(5,5-dimethyl-1-cyclohexenyl) pent-4-en-1-one), Plicatone (CAS 41724-19-0), Veloutone (2,2,5-trimethyl-5-pentylcyclopentan-1-one), 2,4,4,7-tetramethyl-oct-6-en-3-one and/or tetramerane (6,10-dimethylundecen-2-one). Mixtures of said substances may also be used.

In a further embodiment, an odorant may be an alcohol, preferably selected from 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenyl-pentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, di-hydromyrcenol, dimethylbenzylcarbinol, dimethylheptanol, dimethyloctanol, ethylsalicylate, ethylvanillin, eugenol, farnesol, geraniol, heptanol, hexylsalicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol. Mixtures of said substances may also be used.

Fragrance compounds of the ester type are e.g., benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate. The ethers include, for example, benzyl ethyl ether and Ambroxan, and the hydrocarbons predominantly include terpenes, such as limonene and pinene. However, mixtures of different odorants are preferably used which together produce an appealing fragrance note.

In another embodiment, an odorant may be an essential oil, such as angelica root oil, aniseed oil, arnica blossom oil, basil oil, bay oil, champaca blossom oil, citrus oil, abies alba oil, abies alba cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamic alcohol, indole, irone, isoeugenol, isoeugenol methyl ether, isosafrole, jasmine, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl beta-naphthyl ketone, methyl n-nonylacetaldehyde, methyl n-nonyl ketone, muscone, beta-naphthol ethyl ether, beta-naphthol methyl ether, nerol, n-nonylaldehyde, nonyl alcohol, n-octylaldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, skatole, terpineol, thyme, thymol, gamma-undecalactone, vanillin, veratraldehyde, cinnamaldehyde, cinnamic alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal and mixtures thereof. Mixtures of said substances may also be used.

Suitable odorant compounds can be found in Table 1, but all other odorant compounds that are known to and considered suitable by a person skilled in the art are also included in the context of the invention, as long as at least one of the odorant compounds in the perfume composition according to the invention has a blooming coefficient of ≥0.5.

TABLE 1

| Odorant | VP25° [Pa] | ODT [μg/m³] | Bc |
|---|---|---|---|
| Manzanate | 383.96 | 0.2 | 1919.800 |
| Ethyl-2-methylbutyrate | 1070.5 | 0.7 | 1529.286 |
| Ethyl butyrate | 1946.5 | 2.2 | 884.773 |
| Aldehyde c 07 | 469.29 | 2.6 | 180.496 |
| Isopropyl methyl-2-butyrate | 711.94 | 8.6 | 82.784 |
| Hexenyl acetate | 151.98 | 2.5 | 60.792 |
| Aldehyde c 06 | 1275.8 | 22 | 57.991 |
| Neoproxen | 277.31 | 6.4 | 43.330 |
| Cerezoate | 279.97 | 7 | 39.996 |
| Aldehyde c 08 | 198.65 | 5.3 | 37.481 |
| Melonal | 101.19 | 3 | 33.730 |
| Eucalyptus globulus oil | 207.98 | 7 | 29.711 |
| Hexenal-2-trans | 629.28 | 27 | 23.307 |
| Prenyl acetate | 555.95 | 36 | 15.443 |
| Romilat | 2239.8 | 190 | 11.788 |
| Cresyl methyl ether (para) | 159.98 | 19 | 8.420 |
| Methyl hexyl ketone | 249.31 | 32 | 7.791 |
| Ethyl acetate | 13105 | 2200 | 5.957 |
| Pinane | 291.97 | 51 | 5.725 |
| Sulfox | 0.99725 | 0.2 | 4.986 |
| Amyl propionate | 222.64 | 50 | 4.453 |
| Koumalactone | 0.85326 | 0.3 | 2.844 |
| Methylbutyl-2 propionate | 383.96 | 160 | 2.400 |
| Isopentyrate | 132.25 | 64 | 2.066 |
| Hexanol | 117.45 | 63 | 1.864 |
| Hexenol (beta gamma) | 124.92 | 71 | 1.759 |
| Hexyl acetate | 193.31 | 130 | 1.487 |
| Benzaldehyde pure | 134.65 | 96 | 1.403 |
| 2-ethyl-5(6)-methylpyrazine | 81.06 | 57.8 | 1.402 |
| Cymol (para) = cymene | 151.98 | 170 | 0.894 |
| Gyrane | 33.73 | 41 | 0.823 |
| Amyl valerianate, iso-iso- | 77.46 | 110 | 0.704 |

In various embodiments, the at least one odorant having a blooming coefficient of ≥0.5 is selected from the group consisting of manzanate, ethyl-2-methylbutyrate, ethyl butyrate, aldehyde c 07 (heptanal), isopropylmethyl-2-butyrate, hexenyl acetate, aldehyde c 06 (hexanal), neoproxen, cerezoate, aldehyde c 08 (octanal), Melonal, eucalyptus globulus oil, trans-2-hexenal, prenyl acetate, Romilat, (para-) cresyl methyl ether, methyl hexyl ketone, ethyl acetate, pinane, Sulfox, amyl propionate, Koumalactone, methylbutyl-2 propionate, isopentyrate, hexanol, (beta-) hexenol, (gamma-) hexenol, hexyl acetate, benzaldehyde (pure), 2-ethyl-5-methylpyrazine, 2-ethyl-6-methylpyrazine, (para-) cymene (p-cymene), gyrane, iso-iso-amyl valerianate (3-methylbutyl isovalerate) and mixtures thereof.

In the context of the present invention, individual odorants of the perfume composition according to the invention may be present in free form, as pro-fragrances or in encapsulated form, without being limited thereto. Furthermore, the fragrances can be applied to specific carrier molecules. However, free odorants are particularly preferably used.

In a further aspect, the invention relates to a washing or cleaning agent comprising the perfume composition according to the invention.

This subject matter of the invention includes all conceivable types of washing or cleaning agents, both concentrates and undiluted agents, for use on a commercial scale, in washing machines or for hand washing or cleaning. These include, for example, washing agents for textiles, carpets or natural fibers for which the term washing agent is used. These include, for example, dishwashing detergents for dishwashers or manual dishwashing detergents or cleaners for hard surfaces such as metal, glass, porcelain, ceramics, tiles, stone, painted surfaces, plastics, wood or leather, for which the term cleaning agent is used, i.e. in addition to manual and mechanical dishwashing detergents, also, for example, scouring agents, glass cleaners, WC toilet scenters, etc. The washing or cleaning agents according to the invention also include auxiliary washing agents which are added to the actual washing agent during manual or automatic textile washing in order to achieve a further effect. Furthermore, in the context of the invention, washing or cleaning agents also include textile pre-treatment agents and post-treatment agents, i.e., those agents with which the item of laundry is brought into contact before the actual washing, for example for dissolving stubborn stains, and also those agents which give the laundry further desirable properties, such as a pleasant feel, crease resistance or a low static charge in a step downstream of the actual textile washing. Inter alia, softeners are included in the latter agents.

In preferred embodiments, the perfume composition according to the invention is used in the washing or cleaning agent in an amount of from 0.001 to 30 wt. %, preferably from 0.01 to 20 wt. %, more preferably from 0.1 to 10 wt. %, in particular from 0.5 to 5 wt. %, for example 1 wt. %, based on the total weight of the washing or cleaning agent.

The washing or cleaning agent described herein can be solid or liquid. However, the washing or cleaning agents according to the invention are preferably liquid in nature and can in particular be present as homogeneous solutions or suspensions.

“Liquid,” as used herein, includes liquids and gels as well as pasty compositions. It is preferred that the liquid compositions are flowable and pourable at room temperature, but it is also possible for them to have a limit of liquidity.

In this context, “solid” means that the composition is present as a solid, in particular as a powder or granules or compactate, under standard conditions.

In various embodiments of the invention, the washing or cleaning agent is in a pre-portioned form, preferably in the form of a unit dose, for example encased by a water-soluble film. In this case, the washing or cleaning agent can also have a plurality of compositions that are spatially separated from one another, whereby, on the one hand, it is possible to separate incompatible ingredients from one another and, on the other hand, it is possible to offer compositions in combination that are used at different times.

In various embodiments, the washing or cleaning agent according to the invention can contain at least one further constituent, preferably at least two further constituents, preferably selected from the group consisting of builders, surfactants, polymers, water-miscible solvents, pH regulators, enzymes, enzyme stabilizers/inhibitors, electrolytes, bleaching agents, bleach catalysts, bleach activators, hydrotropes, foam regulators/inhibitors, dyes, fluorescent agents, silicone oils, soil-release polymers, graying inhibitors, anti-shrink agents, anti-crease agents, antimicrobial active ingredients, germicides, fungicides, antioxidants, preservatives, corrosion inhibitors, antistats, bittering agents, ironing aids, repellent and impregnation agents, skin care active ingredients, anti-swelling and anti-slip agents, complexing agents, plasticizing components, UV absorbers, other odorants or pro-fragrances as well as perfume carriers, without being limited thereto. The use of one or more further constituents depends on the desired use of the washing or cleaning agent.

Preferably, the washing or cleaning agent according to the invention can contain a further constituent, preferably at least two further constituents, selected from the group consisting of further odorants or odorant storage compounds, builders, surfactants, complexing agents, polymers, water-miscible solvents, pH regulators, enzymes, enzyme stabilizers/inhibitors, bleaching agents, bleach catalysts, bleach activators, foam regulators, and dyes.

The general production and composition of detergents and cleaning agents is basically known to a person skilled in the art in this field.

Suitable surfactants are, for example, all known non-ionic, anionic, cationic, zwitterionic, and amphoteric surfactants, wherein at least non-ionic and/or anionic surfactants are used in various embodiments.

In various embodiments, the agent can contain 0.5 to 50 wt. % surfactants, preferably 1 to 40 wt. %, in particular 5 to 30 wt. %.

All non-ionic surfactants that are known to a person skilled in the art can be used as non-ionic surfactants. Non-ionic surfactants that are preferably used come from the group of the alkoxylated non-ionic surfactants, in particular the ethoxylated primary alcohols and mixtures of these surfactants with structurally complex surfactants such as polyoxypropylene/polyoxyethylene/polyoxypropylene ((PO/EO/PO) surfactants).

Preferred anionic surfactants are fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates and lignosulfonates. Likewise, fatty acid cyanamides, sulfosuccinates (sulfosuccinic acid esters), in particular sulfosuccinic acid mono- and di-C₈-C₁₈ alkyl esters, sulfosuccinamates, sulfosuccinamides, fatty acid isethionates, acylamino alkane sulfonates (fatty acid taurides), fatty acid sarcosinates, ether carboxylic acids and alkyl (ether) phosphates, and a-sulfo fatty acid salts, acylglutamates, monoglyceride disulfates and alkyl ethers of glycerol disulfate can also be used within the scope of the present invention.

The anionic surfactants are preferably used as sodium salts, but can also be contained as other alkali or alkaline-earth metal salts, for example potassium or magnesium salts, and in the form of ammonium salts or mono-, di-, tri- or tetraalkylammonium salts, and in the case of the sulfonates, also in the form of their corresponding acids, e.g., dodecylbenzenesulfonic acid.

Suitable amphoteric surfactants are, for example, betaines of formula (Rⁱⁱⁱ)(R^{iv})(R^{v})N⁺CH₂COO⁻; where Rⁱⁱⁱ denotes an alkyl group, which is optionally interrupted by heteroatoms or heteroatom groups, having 8 to 25, preferably 10 to 21, carbon atoms, and where R^{iv} and R^{v} denote identical or different alkyl groups having 1 to 3 carbon atoms, in particular C₁₀-C₁₈ alkyl dimethyl carboxymethyl betaine and C₁₁-C₁₇ alkyl amidopropyl dimethyl carboxymethyl betaine.

For example, amine oxides can be used as zwitterionic surfactants.

Suitable cationic surfactants are, inter alia, the quaternary ammonium compounds of formula (R^{vi})(R^{vii})(R^{viii})(R^{ix})N⁺X⁻, where R^{vi} to R^{ix} are four identical or different, in particular two long-chain and two short-chain, alkyl groups, and where X⁻ is an anion, in particular a halide ion, e.g. didecyl dimethyl ammonium chloride, alkyl benzyl didecyl ammonium chloride and the mixtures thereof. Further suitable cationic surfactants are the quaternary surface-active compounds, in particular having a sulfonium, phosphonium, iodonium or arsonium group, which are also known as antimicrobial active ingredients. By using quaternary surface-active compounds having an antimicrobial effect, the agent can be provided with an antimicrobial effect or the antimicrobial effect that may already be present due to other ingredients can be improved.

An agent according to the invention preferably contains at least one water-soluble and/or water-insoluble, organic and/or inorganic builder. The water-soluble organic builder substances include polycarboxylic acids, in particular citric acid and saccharic acids; monomer and polymer aminopolycarboxylic acids, in particular methylglycinediacetic acid, nitrilotriacetic acid, ethylenediaminetetraacetic acid and polyaspartic acid; polyphosphonic acids, in particular aminotris(methylene phosphonic acid), ethylenediaminetetrakis(methylene phosphonic acid) and 1-hydroxyethane-1,1-diphosphonic acid; polymer hydroxy compounds such as dextrin; and polymer (poly) carboxylic acids, in particular the polycarboxylates which can be obtained by oxidation of polysaccharides or dextrins; polymer acrylic acids, methacrylic acids, maleic acids and mixed polymers thereof, which may also contain small proportions of polymerizable substances without carboxylic acid functionality in polymerized form. The relative molecular mass of the homopolymers of unsaturated carboxylic acids is generally between 3,000 and 200,000, that of the copolymers is between 2,000 and 200,000, preferably 30,000 to 120,000, in each case based on free acid. A particularly preferred acrylic acid-maleic acid copolymer has a relative molecular weight of 30,000 to 100,000. Commercial products are, for example, Sokalan® CP 5, CP 10 and PA 30 from BASF. Suitable, albeit less preferred compounds of this class are copolymers of acrylic acid or methacrylic acid with vinyl ethers, such as vinyl methyl ethers, vinyl esters, ethylene, propylene, and styrene, in which the proportion of the acid is at least 50 wt. %. It is also possible to use, as water-soluble organic builder substances, terpolymers which contain two unsaturated acids and/or the salts thereof as monomers and vinyl alcohol and/or an esterified vinyl alcohol or a carbohydrate as the third monomer. The first acid monomer or the salt thereof is derived from a monoethylenically unsaturated C₃-C₈ carboxylic acid and preferably from a C₃-C₄ monocarboxylic acid, in particular from (meth)acrylic acid. The second acidic monomer or the salt thereof can be a derivative of a C₄-C₈ dicarboxylic acid, maleic acid being particularly preferred, and/or a derivative of an allylsulfonic acid which is substituted in the 2nd position with an alkyl or aryl group. Such polymers generally have a relative molecular mass between 1,000 and 200,000. Further preferred copolymers are those which preferably have acrolein and acrylic acid/acrylic acid salts or vinyl acetate as monomers. The organic builder substances may, in particular for the preparation of liquid agents, be used in the form of aqueous solutions, preferably in the form of 30 to 50 wt. % aqueous solutions. All of said acids are generally used in the form of their water-soluble salts, in particular their alkali salts.

Organic builder substances of this kind can, if desired, be contained in amounts of up to 40 wt. %, in particular up to 25 wt. %, and preferably from 1 wt. % to 8 wt. %. Amounts close to the stated upper limit are preferably used in pasty or liquid, in particular water-containing, agents.

In particular, alkali silicates, alkali carbonates and alkali phosphates, which can be present in the form of their alkaline, neutral, or acidic sodium or potassium salts, can be used as water-soluble inorganic builder materials. Examples thereof are trisodium phosphate, tetrasodium diphosphate, disodium dihydrogen diphosphate, pentasodium triphosphate, sodium hexametaphosphate, oligomeric trisodium phosphate with degrees of oligomerization of 5 to 1,000, in particular 5 to 50, and the corresponding potassium salts or mixtures of sodium and potassium salts. In particular crystalline or amorphous alkali aluminosilicates are used as water-insoluble, water-dispersible inorganic builder materials in amounts of up to 50 wt. %, preferably no greater than 40 wt. %, and in liquid agents in particular in amounts of from 1 wt. % to 5 wt. %. Among these, the crystalline sodium aluminosilicates in detergent quality, in particular zeolite A, P, and optionally X, either alone or in mixtures, for example in the form of a co-crystallizate of the zeolites A and X (Vegobond® AX, a commercial product of Condea Augusta S.p.A.), are preferred. Amounts close to the stated upper limit are preferably used in solid, particulate agents. Suitable aluminosilicates have, in particular, no particles having a particle size above 30 μm and preferably consist by at least 80 wt. % of particles having a size below 10 μm. Their calcium binding capacity, which can be determined, for example, according to the specifications in German patent DE2412837, is generally in the range of from 100 to 200 mg CaO per gram.

Suitable substitutes or partial substitutes for the above-mentioned aluminosilicate are crystalline alkali silicates, which can be present alone or in a mixture with amorphous silicates. The alkali silicates that can be used in the agents as builders preferably have a molar ratio of alkali oxide to SiO₂ of less than 0.95, in particular from 1:1.1 to 1:12, and may be present in amorphous or crystalline form. Preferred alkali silicates are sodium silicates, in particular amorphous sodium silicates, having a molar ratio of Na₂O:SiO₂ of from 1:2 to 1:2.8. As crystalline silicates, which may be present alone or in admixture with amorphous silicates, crystalline phyllosilicates of general formula Na₂SiₓO₂ₓ₊₁·yH₂O are preferably used, in which x, known as the modulus, is a number from 1.9 to 22, in particular 1.9 to 4, and y is a number from 0 to 33, and preferred values for x are 2, 3 or 4. Preferred crystalline phyllosilicates are those in which x assumes the values 2 or 3 in the mentioned general formula. In particular, both β- and δ-sodium disilicates (Na₂Si₂O₅·yH₂O) are preferred. Practically water-free crystalline alkali silicates which have the above general formula, in which x is a number from 1.9 to 2.1, and which are prepared from amorphous alkali silicates may also be used in agents within the meaning of the invention. In another preferred embodiment of the agent, a crystalline sodium phyllosilicate having a modulus of 2 to 3 is used, such as can be produced from sand and soda ash. Crystalline sodium silicates having a module in the range of from 1.9 to 3.5 are used in a further preferred embodiment of the agent. Crystalline phyllosilicates of the above formula (I) are sold by Clariant GmbH under the trade name Na-SKS, for example Na-SKS-1 (Na₂Si₂₂O₄₅·xH₂O, kenyaite), Na-SKS-2 (Na₂Si₁₄O₂₉·xH₂O, magadiite), Na-SKS-3 (Na₂Si₈O₁₇·xH₂O) or Na-SKS-4 (Na₂Si₄O₉·xH₂O, macatite). Of these, Na-SKS-5 (α-Na₂Si₂O₅), Na-SKS-7 (β-Na₂Si₂O₅, natrosilite), Na-SKS-9 (NaHSi₂O₅·3H₂O), Na-SKS-10 (NaHSi₂O₅·3H₂O, kanemite), Na-SKS-11 (t-Na₂Si₂O₅) and Na-SKS-13 (NaHSi₂O₅), and in particular Na-SKS-6 (δ-Na₂Si₂O₅), are particularly suitable. In a preferred embodiment of an agent within the meaning of the invention, a granular compound made of crystalline phyllosilicate and citrate, crystalline phyllosilicate and the above-described (co)polymeric polycarboxylic acid, or alkali silicate and alkali carbonate is used, as is commercially available under the name Nabion® 15, for example.

Builder substances are preferably present in the agents in amounts of up to 75 wt. %, and in particular of 5 wt. % to 50 wt. %.

The organic solvents that can be used in the washing or cleaning agents according to the invention, in particular when the agents are present in liquid or pasty form, include alcohols having 1 to 4 C atoms, in particular methanol, ethanol, isopropanol, and tert-butanol, diols having 2 to 4 C atoms, in particular ethylene glycol and propylene glycol, and mixtures thereof, and the ethers that can be derived from the mentioned compound classes. Water-miscible solvents of this kind are present in the agents preferably in amounts of no greater than 30 wt. %, in particular of 6 wt. % to 20 wt. %. The organic solvents used are particularly preferably miscible with water.

Furthermore, the washing or cleaning agent according to the invention can contain enzymes, for example, without being limited thereto, amylases, proteases, cellulases, glycosidases, hemicellulases, mannanases, xylanases, pectinases, β-glucosidases, carrageenases, lipases, oxidases, oxidoreductases, or combinations thereof. Amylases and/or proteases are preferably used. In addition, the agents can contain enzyme stabilizers or inhibitors.

In various embodiments, the composition according to the invention or the agent according to the invention is phosphate-free and/or phosphonate-free. “Phosphate-free” and “phosphonate-free,” as used herein, mean that the composition in question is substantially free of phosphates or phosphonates, i.e., in particular contains phosphates or phosphonates in amounts of less than 0.1 wt. %, preferably less than 0.01 wt. %, based on the particular composition or the particular agent.

In general, the pH of the compositions or agents can be adjusted using standard pH regulators. Acids and/or alkalis, preferably alkalis, are used as pH adjusters. Suitable acids are, in particular, organic acids, such as acetic acid, citric acid, glycolic acid, lactic acid, succinic acid, adipic acid, malic acid, tartaric acid and gluconic acid, or sulfamic acid. In addition, however, the mineral acids hydrochloric acid, sulfuric acid and nitric acid or mixtures thereof can also be used. Suitable bases originate from the group of alkali and alkaline-earth metal hydroxides and carbonates, in particular alkali metal hydroxides, of which potassium hydroxide is preferred. The alkali source described above is particularly preferably used to adjust the pH. Even if volatile alkali, for example in the form of ammonia and/or alkanolamines, which can contain up to 9 carbon atoms in the molecule, can be used to adjust the pH, it being possible for the alkanolamine to be selected from the group consisting of mono-, di-, triethanol-and-propanolamine and mixtures thereof, volatile alkali sources of this kind, in particular ethanolamines, are preferably avoided. In various embodiments, the compositions therefore contain less than 1.75 wt. % of alkanolamine, in particular monoethanolamine, and are very particularly preferably free of same. It has been found that the omission of such alkanolamines increases the stability of the compositions or agents.

To adjust and/or stabilize the pH, the composition according to the invention or the agent according to the invention can also contain one or more buffer substances (INCI buffering agents), usually in amounts from 0.001 to 5 wt. %. Buffer substances, which are also complexing agents or even chelating agents (chelators, INCI chelating agents), are preferred. Particularly preferred buffer substances are citric acid or citrates, in particular sodium and potassium citrates, for example trisodium citrate·2H₂O and tripotassium citrate·H₂O.

Other advantageous ingredients that can be used in the agents according to the invention are also disclosed, for example, in the international patent application WO2009/121725, starting on page 5, penultimate paragraph, and ending on page 13 after the second paragraph.

The agents described herein can be packaged in different ways. The liquid presentation forms based on water and/or organic solvents can be present in thickened form, in the form of gels.

In various embodiments, the agent or the corresponding liquid composition has a viscosity above 200 mPas (Brookfield Viscometer DV-II+Pro, spindle 25, 30 rpm, 20° C.), in particular between 400 and 6,000 mPas, immediately after preparation.

The washing and cleaning agents described herein are preferably pre-packaged into dosing units. These dosing units preferably comprise the amount of washing-active or cleaning-active substances necessary for a cleaning cycle. Preferred dosing units have a weight between 12 and 30 g. The volume of the aforementioned dosing units and the spatial shape thereof are particularly preferably selected so that the pre-packaged units can be dosed via the dosing chamber of a washing machine or dishwasher. The volume of the dosing unit is therefore preferably between 10 and 35 ml, preferably between 12 and 30 ml.

The washing and cleaning agents, in particular the prefabricated dosing units, particularly preferably have a water-soluble wrapping.

The water-soluble wrapping is preferably made from a water-soluble film material, which is selected from the group consisting of polymers or polymer mixtures. The wrapping may be made up of one or of two or more layers of the water-soluble film material. The water-soluble film material of the first layer and of the additional layers, if present, may be the same or different. Particularly preferred are films which, for example, can be glued and/or sealed to form packaging such as tubes or sachets after they have been filled with an agent. In various embodiments, the films are in the form of multi-chamber pouches in which different compositions or components can be spatially separated.

In various embodiments, the water-soluble wrapping contains polyvinyl alcohol or a polyvinyl alcohol copolymer. Water-soluble wrappings containing polyvinyl alcohol or a polyvinyl alcohol copolymer exhibit good stability with a sufficiently high level of water solubility, in particular cold-water solubility.

Suitable water-soluble films for producing the water-soluble wrapping are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹ and in particular from 40,000 to 80,000 gmol⁻¹.

Polyvinyl alcohol is usually prepared by hydrolysis of polyvinyl acetate, since the direct synthesis route is not possible. The same applies to polyvinyl alcohol copolymers, which are prepared accordingly from polyvinyl acetate copolymers. It is preferable for at least one layer of the water-soluble wrapping to include a polyvinyl alcohol of which the degree of hydrolysis is 70 to 100 mol. %, preferably 80 to 90 mol. %, particularly preferably 81 to 89 mol. %, and in particular 82 to 88 mol. %.

In addition, a polymer selected from the group comprising (meth)acrylic acid-containing (co) polymers, polyacrylamides, oxazoline polymers, polystyrene sulfonates, polyurethanes, polyesters, polyethers, polylactic acid or mixtures of said polymers may be added to a polyvinyl alcohol-containing film material that is suitable for producing the water-soluble wrapping. Polylactic acids are a preferred additional polymer.

Preferred polyvinyl alcohol copolymers include, in addition to vinyl alcohol, dicarboxylic acids as further monomers. Suitable dicarboxylic acids are itaconic acid, malonic acid, succinic acid and mixtures thereof, itaconic acid being preferred.

Polyvinyl alcohol copolymers which include, in addition to vinyl alcohol, an ethylenically unsaturated carboxylic acid, or the salt or ester thereof, are also preferred. Polyvinyl alcohol copolymers of this kind particularly preferably contain, in addition to vinyl alcohol, acrylic acid, methacrylic acid, acrylic acid ester, methacrylic acid ester or mixtures thereof.

It may be preferable for the film material to contain further additives. The film material may contain plasticizers such as dipropylene glycol, ethylene glycol, diethylene glycol, propylene glycol, glycerol, sorbitol, mannitol or mixtures thereof, for example. Further additives include, for example, release aids, fillers, cross-linking agents, surfactants, antioxidants, UV absorbers, anti-blocking agents, anti-adhesive agents or mixtures thereof.

Suitable water-soluble films for use in the water-soluble wrappings of the water-soluble packaging according to the invention are films which are sold by MonoSol LLC, for example under the names M8630, C8400 or M8900. Other suitable films include films with the name Solublon® PT, Solublon® GA, Solublon® KC or Solublon® KL by Aicello Chemical Europe GmbH or the VF-HP films by Kuraray.

In preferred embodiments, the washing or cleaning agent is present
(a) in liquid form; and/or
(b) in the form of a unit dose, preferably surrounded by a water-soluble film; and/or
(c) in a phosphate-free and/or phosphonate-free form.

The corresponding use of the perfume compositions according to the invention or of the washing or cleaning agents according to the invention is also a subject matter of the invention.

One aspect of the invention is the use of the perfume composition according to the invention or of the washing or cleaning agent according to the invention
(i) for washing textiles and/or for scenting the room in which the composition or agent is applied; or
(ii) for cleaning surfaces and/or for scenting the room in which the composition or agent is applied.

Particularly preferably, the surface to be cleaned is a fabric, a dish, a piece of furniture, a floor, or (wall) tiles, in particular a hard surface such as a dish, a piece of furniture, a floor, or (wall) tiles.

The invention preferably relates to the use of the perfume composition according to the invention or of the washing or cleaning agent according to the invention for washing textiles or for cleaning surfaces and simultaneously for scenting the room in which the composition or agent is applied.

In particular, the application of the perfume composition according to the invention or the washing or cleaning agent according to the invention causes a room-filling perfume effect. This effect preferably occurs in addition to the cleaning (washing) of textiles or in addition to the cleaning of other surfaces, preferably hard surfaces. In this case, the room-filling effect occurs both during application, for example when mopping a floor, or during the washing of textiles, for example, hand washing, and then, for example, when the washing machine is opened or the laundry is dried on the line. It is particularly preferred that the room-filling perfume effect lasts for a long time in the room. It preferably lasts at least 30 seconds from the end of the application, more preferably at least 1 minute, even more preferably at least 2 minutes, even more preferably at least 5 minutes, even more preferably at least 10 minutes, even more preferably at least 15 minutes, even more preferably at least 30 minutes, even more preferably at least 60 minutes or in particular at least 120 minutes or longer from the end of the application.

A further subject matter of the invention is a method
(i) for washing textiles and/or for scenting the room in which the method is carried out; or
(ii) for cleaning surfaces and/or for scenting the room in which the method is carried out; characterized in that in at least one method step a perfume composition according to the invention or a washing or cleaning agent according to the invention is applied.

The invention preferably relates to a method for washing textiles or for cleaning surfaces and simultaneously for scenting the room in which the method is carried out, characterized in that in at least one method step a perfume composition according to the invention or a washing or cleaning agent according to the invention is applied.

Particularly preferably, the surface to be cleaned is a fabric, a dish, a piece of furniture, a floor, or (wall) tiles, in particular a hard surface such as a dish, a piece of furniture, a floor, or (wall) tiles.

The method according to the invention comprises, for example, washing textiles in an automatic washing machine or cleaning dishes in a dishwasher, wherein the agent according to the invention or the composition according to the invention is metered into the interior of a washing machine or dishwasher during a washing or dishwashing program before the main washing cycle is started or during the main washing cycle. The metering or introduction of the agent according to the invention into the interior of the washing machine or dishwasher can take place manually; alternatively, the agent is metered into the interior of the washing machine or dishwasher by means of the metering chamber.

In addition to the machine method, the method according to the invention also comprises manual methods, wherein machine methods are preferred. Manual methods can be, for example, cleaning, for example brushing or wiping, floor surfaces or wall tiles. Furthermore, the manual washing of textiles is comprised. The methods according to the invention are characterized in particular in that the composition according to the invention or the washing or cleaning agent according to the invention is brought into contact with the articles to be cleaned in one or more method steps. The composition or the agent may be used undiluted or, for example, diluted with water or another suitable solvent. In addition, the articles to be cleaned can be treated simultaneously or successively with other components, compositions or agents.

Preferably, by using the composition according to the invention or the agent according to the invention, the relevant odorant molecules are released and, due to their properties, can cause the desired room-filling perfume effect, which particularly preferably lasts for some time in the room as defined above.

All aspects, subjects and embodiments described for the perfume composition according to the invention or the washing or cleaning agent according to the invention are also applicable to further subjects of the invention. Therefore, reference is expressly made at this point to the disclosure at the appropriate point with the note that this disclosure also applies to the above-described uses and methods according to the invention.

### EXAMPLES

### Example 1

TABLE 1
Odorants with associated vapor pressure, odor detection threshold,
and blooming coefficient (Bc) resulting therefrom.

| Odorant | VP25° [Pa] | ODT [μg/m³] | Bc |
|---|---|---|---|
| Manzanate | 383.96 | 0.2 | 1919.800 |
| Ethyl-2-methylbutyrate | 1070.5 | 0.7 | 1529.286 |
| Ethyl butyrate | 1946.5 | 2.2 | 884.773 |
| Aldehyde c 07 | 469.29 | 2.6 | 180.496 |
| Isopropyl methyl-2-butyrate | 711.94 | 8.6 | 82.784 |
| Hexenyl acetate | 151.98 | 2.5 | 60.792 |
| Aldehyde c 06 | 1275.8 | 22 | 57.991 |
| Neoproxen | 277.31 | 6.4 | 43.330 |
| Cerezoate | 279.97 | 7 | 39.996 |
| Aldehyde c 08 | 198.65 | 5.3 | 37.481 |
| Melonal | 101.19 | 3 | 33.730 |
| Eucalyptus globulus oil | 207.98 | 7 | 29.711 |
| Hexenal-2-trans | 629.28 | 27 | 23.307 |
| Prenyl acetate | 555.95 | 36 | 15.443 |
| Romilat | 2239.8 | 190 | 11.788 |
| Cresyl methyl ether (para) | 159.98 | 19 | 8.420 |
| Methyl hexyl ketone | 249.31 | 32 | 7.791 |
| Ethyl acetate | 13105 | 2200 | 5.957 |
| Pinane | 291.97 | 51 | 5.725 |
| Sulfox | 0.99725 | 0.2 | 4.986 |
| Amyl propionate | 222.64 | 50 | 4.453 |
| Koumalactone | 0.85326 | 0.3 | 2.844 |
| Methylbutyl-2 propionate | 383.96 | 160 | 2.400 |
| Isopentyrate | 132.25 | 64 | 2.066 |
| Hexanol | 117.45 | 63 | 1.864 |
| Hexenol (beta gamma) | 124.92 | 71 | 1.759 |
| Hexyl acetate | 193.31 | 130 | 1.487 |
| Benzaldehyde pure | 134.65 | 96 | 1.403 |
| 2-ethyl-5(6)-methylpyrazine | 81.06 | 57.8 | 1.402 |
| Cymol (para) = cymene | 151.98 | 170 | 0.894 |
| Gyrane | 33.73 | 41 | 0.823 |
| Amyl valerianate, iso-iso- | 77.46 | 110 | 0.704 |
| Claritone | 36.53 | 95 | 0.385 |
| Ethyl acetoacetate | 123.85 | 400 | 0.310 |
| Vivaldie | 135.98 | 510 | 0.267 |
| Nerol (nerolione) | 0.20131 | 1.6 | 0.126 |
| Undecavertol | 0.79326 | 11 | 0.072 |
| Methyl laitone 10%-dpg | 0.61861 | 13 | 0.048 |
| Isobutyl salicylate | 0.80126 | 40 | 0.020 |
| Aldehyde c 16 sog | 0.42263 | 23 | 0.018 |
| Menoxaline | 0.67994 | 39.6 | 0.017 |
| Decalactone (delta) | 0.63328 | 38.9 | 0.016 |
| Sulfurol (4-methyl-5-thiazole | 0.22798 | 15 | 0.015 |
| ethanol) | | | |
| Cyclomyral | 0.53195 | 36 | 0.015 |
| Dihydroeugenol | 0.28397 | 23 | 0.012 |
| Isocyclogeraniol | 0.99591 | 89 | 0.011 |
| Amber extreme | 0.21331 | 20.7 | 0.010 |
| Ambrocenide 10% dpg | 0.050262 | 5.3 | 0.009 |
| Buccoxime | 0.081326 | 11 | 0.007 |
| Coumarin | 0.087592 | 12 | 0.007 |
| Vertacetal | 0.39063 | 63 | 0.006 |
| Methyl diantilis | 0.07946 | 15 | 0.005 |
| Huminol (0.1%) | 0.64794 | 140 | 0.005 |
| Calone | 0.096525 | 23 | 0.004 |
| Trisamber | 0.3653 | 88 | 0.004 |
| Methyl naphthyl ketone cryst. | 0.12119 | 30 | 0.004 |
| Benzophenone cryst. | 0.12079 | 36 | 0.003 |
| Aprifloren | 0.36796 | 121.3 | 0.003 |
| Borneol | 0.057195 | 20 | 0.003 |
| Dimethyl phenyl ethyl carbinol | 0.53062 | 270 | 0.002 |
| Undecylenic alcohol alcohol c 11 en | 0.43329 | 230 | 0.002 |
| Malyl isobutyrate | 0.19865 | 110 | 0.002 |
| Oxyphenylone | 0.095458 | 55 | 0.002 |
| Jasmelia | 0.93725 | 570 | 0.002 |
| Hydroxycitronellal pure | 0.77326 | 500 | 0.002 |
| Allyl ionone (Cetone V) | 0.36397 | 250 | 0.001 |
| Ethyl vanillin | 0.039063 | 30 | 0.001 |
| Phenylacetic acid | 0.51729 | 400 | 0.001 |
| Scentenal | 0.59461 | 460 | 0.001 |
| Acetisoeugenol | 0.20664 | 180 | 0.001 |
| Aldambre | 0.067327 | 71 | 0.001 |
| Anisyl acetate | 0.34397 | 400 | 0.001 |
| Corps racine | 0.051062 | 60 | 0.001 |
| Nectaryl | 0.12305 | 160 | 0.001 |
| Vertofix coeur | 0.076393 | 150 | 0.001 |
| Maltol | 0.0057061 | 12 | 0.000 |
| Ethyl maltol (Veltol plus) | 0.019331 | 47 | 0.000 |
| Phenoxanol | 0.039863 | 110 | 0.000 |
| Vanillin | 0.062661 | 200 | 0.000 |
| Dihydro isojasmonate | 0.054928 | 250 | 0.000 |
| Hedione | 0.15865 | 770 | 0.000 |
| Muscenone delta | 0.041196 | 200 | 0.000 |
| Isobutavan | 0.03493 | 290 | 0.000 |
| [3R-(3alpha,3abeta,7beta,8aalpha)]- | 0.076393 | 850 | 0.000 |
| 1-(2,3,4,7,8a-hexahydro-3,6,8,8- | | | |
| tetramethyl-1H-3a,7-methanoazulen- | | | |
| 5-yl)ethan-1-one | | | |
| Cinnamic alcohol | 0.3573 | 4000 | 0.000 |
| Rosaphen | 0.015465 | 190 | 0.000 |
| Fixolide np | 0.025197 | 350 | 0.000 |
| Propenylguetol (Proguol) | 0.047862 | 1100 | 0.000 |
| Amber core | 0.015732 | 398.8 | 0.000 |
| Okoumal | 0.0017731 | 57 | 0.000 |
| Ambrettolid | 0.0029864 | 170 | 0.000 |
| Lyral | 0.011425 | 680 | 0.000 |
| Evernyl | 0.00067061 | 72 | 0.000 |
| Benzyl isoeugenol | 0.0018265 | 210 | 0.000 |
| Scentolid | 0.0029864 | 370 | 0.000 |
| Phenylacetaldehyde glyceryl acetal | 0.0026131 | 390 | 0.000 |
| Isopropoxyethyl salicylate | 0.0055595 | 2700 | 0.000 |
| Phenylethyl cinnamate | 0.0022264 | 1200 | 0.000 |
| n-acetyl methyl anthranilate | 0.0012798 | 1800 | 0.000 |
| Phenyl salicylate | 0.00061728 | 4500 | 0.000 |

### Example 2

TABLE 2
Blooming effect when using liquid detergents
and general purpose cleaners

| | | Liquid detergent |
|---|---|---|
| | Liquid detergent | containing 1% |
| | containing 1% | perfume |
| | conventional | according to |
| | perfume | the invention |
| | Intensity after | Intensity after |
| Blooming effect when the | the machine | the machine |
| washing machine is opened | is opened | is opened |
| Product: liquid detergent (50 ml) | 5 | 6.5 |
| Washing machine: Miele | | |
| Softtronic W1734 | | |
| Program: main wash cycle @ | | |
| 40° C. | | |
| Spin number: 1200 rpm | | |
| Water hardness: 12°dH | | |
| Laundry loads: 3 kg of terry | | |
| towels | | |
| Intensity 1 odorless - 10 very | | |
| strong | | |
| Panel: 3 experts | | |
| | | General purpose |
| | General purpose | cleaner containing |
| | cleaner containing | 1% perfume |
| | 1% conventional | according to |
| | perfume | the invention |
| Blooming effect 30 seconds | Intensity 30 | Intensity 30 |
| after application of a general | seconds after | seconds after |
| purpose cleaner | application | application |
| Product: general purpose cleaner | 7 | 8 |
| (12 g/5 \| of water at 30° C.) | | |
| Room size: 2.6 m³ | | |
| Floor size: 2.2 m² (stone tiles) | | |
| Temperature: 20° C. | | |
| Humidity: 50-60% | | |

1. A perfume composition comprising:
at least one odorant in an amount of at least 15 wt. % based on the total weight of the perfume composition,
wherein the at least one odorant has a blooming coefficient (Bc) of ≥0.5, and
wherein the blooming coefficient is calculated according to the following formula:
$$blooming coefficient ( Bc ) = vapor pressure [ Pa ] at 25 ° C . / odor detection threshold [ µg / {m}^{3} ] .$$

2. The perfume composition of claim 1, wherein the at least one odorant is in an amount of at least 20 wt. % based on the total weight of the perfume composition.

3. The perfume composition of claim 1, wherein the at least one odorant has a blooming coefficient of ≥1.

4. The perfume composition of claim 1, wherein the at least one odorant is selected from the group consisting of manzanate, ethyl-2-methylbutyrate, ethyl butyrate, aldehyde c 07 (heptanal), isopropylmethyl-2-butyrate, hexenyl acetate, aldehyde c 06 (hexanal), neoproxen, cerezoate, aldehyde c 08 (octanal), Melonal, eucalyptus globulus oil, trans-2-hexenal, prenyl acetate, Romilat, (para-) cresyl methyl ether, methyl hexyl ketone, ethyl acetate, pinane, Sulfox, amyl propionate, Koumalactone, methylbutyl-2 propionate, isopentyrate, hexanol, (beta-) hexenol, (gamma-) hexenol, hexyl acetate, benzaldehyde (pure), 2-ethyl-5-methylpyrazine, 2-ethyl-6-methylpyrazine, (para-) cymene (p-cymene), gyrane, iso-iso-amyl valerianate (3-methylbutyl isovalerate), and mixtures thereof.

5. A washing or cleaning agent comprising the perfume composition of claim 1.

6. The washing or cleaning agent of claim 5, wherein the perfume composition is in an amount of from 0.01 to 20 wt. % based on the total weight of the washing or cleaning agent.

7. The washing or cleaning agent of claim 5, wherein the washing or cleaning agent further comprises at least one constituent selected from the group consisting of odorants, odorant storage compounds, builders, surfactants, complexing agents, polymers, water-miscible solvents, pH regulators, enzymes, enzyme stabilizers/inhibitors, bleaching agents, bleach catalysts, bleach activators, foam regulators, dyes, and mixtures thereof.

8. The washing or cleaning agent of claim 5, wherein the washing or cleaning agent is in the form of at least one of a liquid or a unit dose.

9. Use of the perfume composition of claim 1:
for washing at least one textile and/or scenting a room in which the at least one textile is located; or
for cleaning at least one surface and/or scenting a room in which the perfume composition is applied.

10. The use of claim 9, wherein the at least one surface is a fabric surface, a dish surface, a furniture surface, a floor surface, or a tile surface.

11. A method comprising:
washing at least one textile and/or scenting a room in which the at least one textile is located using the perfume composition of claim 1; or
cleaning at least one surface and/or scenting a room using the perfume composition of claim 1.

12. The method of claim 11, wherein the at least one surface is a fabric surface, a dish surface, a furniture surface, a floor surface, or a tile surface.

13. The perfume composition of claim 2, wherein the at least one odorant is in an amount of at least 25 wt. % based on the total weight of the perfume composition.

14. The perfume composition of claim 3, wherein the at least one odorant has a blooming coefficient of ≥10.

15. The perfume composition of claim 14, wherein the at least one odorant has a blooming coefficient of ≥100.

16. The washing or cleaning agent of claim 6, wherein the perfume composition is in an amount of from 0.5 to 5 wt. % based on the total weight of the washing or cleaning agent.

17. The washing or cleaning agent of claim 8, wherein the unit dose is surrounded by a water-soluble film.

18. The washing or cleaning agent of claim 8, wherein the unit dose is phosphate-free and/or phosphonate-free.

19. Use of the washing or cleaning agent of claim 5:
for washing at least one textile and/or scenting a room in which the at least one textile is located; or
for cleaning at least one surface and/or scenting a room in which the washing or cleaning agent is applied.

20. A method comprising:
washing at least one textile and/or scenting a room in which the at least one textile is located using the washing or cleaning agent of claim 5; or
cleaning at least one surface and/or scenting a room using the washing or cleaning agent of claim 5.
